(19) United States
(12) Patent Application Publication
(10) Pub. No.: US 2026/0045013 A1
(43) Pub. Date: Feb. 12, 2026

(54) VIDEO DISTRIBUTION SYSTEM AND VIDEO DISTRIBUTION DEVICE

(71) Applicant: TOMODY, INC., Tokyo (JP)

(72) Inventors: Takeshi TOMIMORI, Tokyo (JP); Kousuke KURAUCHI, Tokyo (JP); Kyohei MAGATA, Tokyo (JP); Takatoshi KATSURA, Tokyo (JP)

(21) Appl. No.: 19/336,875

(22) Filed: Sep. 23, 2025

Related U.S. Application Data
(63) Continuation of application No. PCT/JP2024/028584, filed on Aug. 8, 2024.

(51) Int. Cl. G06T 11/60; G06F 3/041; G06F 3/0488; G06Q 30/0601; G06T 7/149; G06V 10/46

(52) U.S. Cl. CPC G06T 11/60; G06F 3/0412; G06F 3/0488; G06Q 30/0643; G06T 7/149; G06V 10/46

(57) ABSTRACT

In a video distribution system, a video captured by a seller terminal is streamed to a purchaser terminal by a video distribution device. The purchaser terminal includes an input accepting unit configured or programmed to accept an instruction for an item in the video that the purchaser wishes to purchase, through a touch operation by the purchaser, and an information accepting unit configured or programmed to accept inputs such as a desired purchase price of the item, and transmit the accepted information as purchase information to the video distribution device via the purchaser purchase information transmitting/receiving unit. A video distributing unit of the video distribution device is configured or programmed to change a display mode of the item in the video for which the received purchase information exists, and perform streaming distribution.

### CROSS REFERENCE TO RELATED APPLICATIONS

This application is a Continuation Application of PCT Application No. PCT/JP2024/028584 filed on Aug. 8, 2024. The entire contents of each application are hereby incorporated herein by reference.

### BACKGROUND OF THE INVENTION

### 1. Field of the Invention

The present invention relates to electronic commerce, and more particularly, to video distribution systems and video distribution devices utilizing live streaming technology.

### 2. Description of the Related Art

In recent years, the spread of electronic commerce (e-commerce) via the Internet has increased opportunities for consumers to purchase products online. Traditional electronic commerce has been conducted by providing product information through websites, where consumers select and purchase products.

For example, Japanese Patent No. 6831027 discloses a method and a device for displaying products in electronic commerce. This technology provides product information via a user interface, allowing consumers to check details of products.

### SUMMARY OF THE INVENTION

However, in the system disclosed in Japanese Patent No. 6831027, a seller is required to prepare a product sales website, which serves as a link destination, when wishing to conduct a transaction for a product that does not have an existing sales website to link to, such as a one-of-a-kind product like a personal belonging, a recycled product, or an artwork. This imposes significant costs on the seller in terms of labor and expenses. Furthermore, because preparing a sales website takes time, the seller may be unable to respond when they wish to sell the product immediately, resulting in missed business opportunities.

Even if a sales website for the product exists, the seller is required to perform maintenance work for creating and updating link information in the video. The maintenance work must be performed each time product information is changed, a new product is added, a URL of a sales link is changed, or the like. This places a heavy burden on the seller.

On the other hand, from the perspective of a purchaser, accuracy of the link information displayed in the video is required. If a purchaser clicks on a product having a broken link and the correct product page fails to be displayed, it can discourage the purchaser from buying.

Example embodiments of the present invention enable a seller to conduct a commercial transaction without the need to prepare product information in advance.

A video distribution system according to an example embodiment of the present invention is a video distribution system for distributing a video related to a commercial transaction via a network, the video distribution system including a seller terminal, a purchaser terminal, and a video distribution device, wherein the seller terminal is configured or programmed to include a video capturing unit configured or programmed to capture the video, and a video transmitting unit configured or programmed to transmit the video to the video distribution device, the video distribution device is configured or programmed to include a video receiving unit configured or programmed to receive the video captured by the seller terminal, from the seller terminal, a video distributing unit configured or programmed to stream the video received by the video receiving unit to the purchaser terminal, a purchase information receiving unit configured or programmed to receive purchase information from the purchaser terminal, and a purchase information recording unit configured or programmed to record the purchase information, the purchaser terminal is configured or programmed to include a streaming receiving unit configured or programmed to receive the video streamed from the video distributing unit, a purchaser display unit configured or programmed to display the video received by the streaming receiving unit, an input accepting unit including a touch panel superimposed on the purchaser display unit and configured or programmed to accept a purchase instruction for an item in the video that a purchaser wishes to purchase, by the purchaser touching a corresponding area of the touch panel, an item image generating unit configured or programmed to extract a contour of the item present in a frame and an area of the video corresponding to the purchase instruction accepted by the input accepting unit, and extract an image of the item from the frame along the contour, an information accepting unit configured or programmed to cause the purchaser display unit to display a screen allowing the purchaser to input information, including a desired purchase price of the item by the purchaser, and accept the information; and a purchaser purchase information transmitting/receiving unit configured or programmed to transmit the item image generated by the item image generating unit, the information accepted by the information accepting unit, and a transaction status of the item as the purchase information to the video distribution device, and the video distribution unit is configured or programmed to compare the item image in the purchase information recording unit with each frame of the video, extract an item in the video corresponding to the item image, change a display mode of the extracted item in the video; and generate a video in which at least either one of the desired purchase price and the transaction status is superimposed and displayed in an area adjacent to the item.

Additionally, a video distribution system according to an example embodiment of the present invention may further include a purchase information transmitting unit configured or programmed to transmit the purchase information to the purchaser terminal, the seller terminal is configured or programmed to further include a seller purchase information transmitting/receiving unit configured or programmed to transmit/receive the purchase information to/from the video distribution device, a seller purchase information recording unit configured or programmed to store the purchase information, and a seller display unit configured or programmed to display a purchase information confirmation screen allowing input of a determination on whether to approve a sale of the item at the desired purchase price, with respect to the purchase information received by the seller purchase information transmitting/receiving unit, and accept input from the seller, the seller purchase information transmitting/receiving unit being configured or programmed to update a transaction status of the purchase information depending on a result of the approval and transmit the purchase information to the video distribution device, and the video distributing unit is configured or programmed to generate a video in which a display mode of the item in the video has been changed according to a transaction status in the purchase information.

Additionally, the input accepting unit may be configured or programmed to cause the purchaser display unit to display the video in a paused state at a frame of the video corresponding to a time when the purchase instruction is accepted, and determine that the purchase instruction is completed when the touch in the area continues for a predetermined period of time.

Additionally, the display mode of the item in the video distributing unit may be a mode highlighting a contour of the extracted item.

Additionally, a video distribution device according to an example embodiment of the present invention is a video distribution device for distributing a video related to a commercial transaction, the video distribution device including a video receiving unit configured or programmed to receive the video captured by a seller terminal, from the seller terminal, a video distributing unit configured or programmed to stream the video received by the video receiving unit to a purchaser terminal, a purchase information receiving unit configured or programmed to receive, from the purchaser terminal, purchase information including an image of an item in the video that the purchaser instructs to purchase via the purchaser terminal, and a price of the item, and a purchase information recording unit configured or programmed to record the purchase information, wherein the video distribution unit is configured or programmed to compare the item image in the purchase information recording unit with each frame of the video, extract an item in the video corresponding to the item image, change a display mode of the extracted item, and generate a video in which the price of the item in the purchase information is superimposed and displayed in an area adjacent to the item.

According to video distribution systems and video distribution devices of example embodiments of the present invention, a commercial transaction can be started immediately without a seller having to set link information related to products to be sold in advance. Additionally, purchasers and sellers can conduct product transactions by communicating interactively with each other in real time.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an overall view of a video distribution system 1 according to an example embodiment of the present invention.

FIG. 2 is a configuration diagram of a seller terminal 2 included in the video distribution system 1.

FIG. 3 is a configuration diagram of a purchaser terminal 3 included in the video distribution system 1.

FIG. 4 is a configuration diagram of a video distribution device 4 included in the video distribution system 1.

FIG. 5 is a flowchart for a commercial transaction using the video distribution system 1.

FIG. 6 is a flowchart for price negotiation between a seller and a purchaser.

FIG. 7 is an example of a distributed video being viewed by the purchaser.

FIG. 8 is an example showing an operation performed when the purchaser selects a product they wish to purchase.

FIG. 9 is an example of an information input screen.

FIG. 10 is an example of a distributed video after the purchaser has input purchase information.

FIG. 11 is an example of a purchase information confirmation screen.

FIG. 12 is an example of a distributed video after the purchaser has input the purchase information.

FIG. 13 is an example of a negotiation screen.

FIG. 14 is an example of a proposal approval screen.

FIG. 15 is an example of the proposal approval screen on which a negotiated price can be input.

### DETAILED DESCRIPTION OF THE EXAMPLE EMBODIMENTS

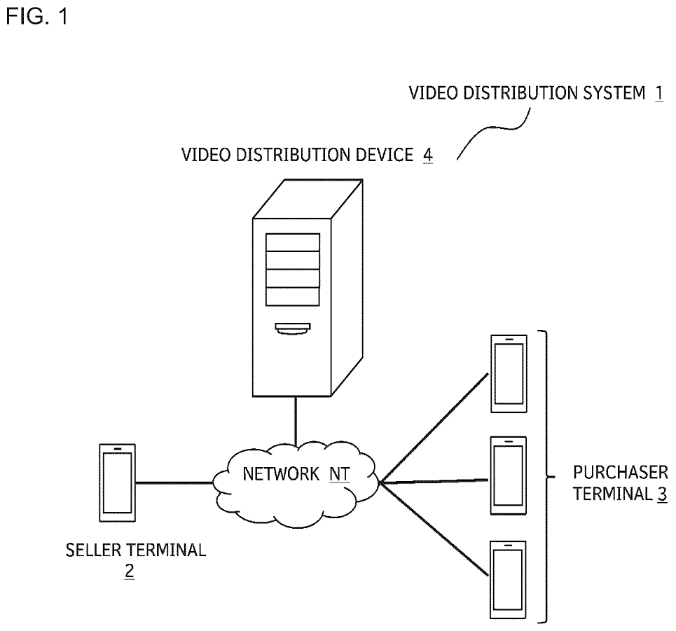

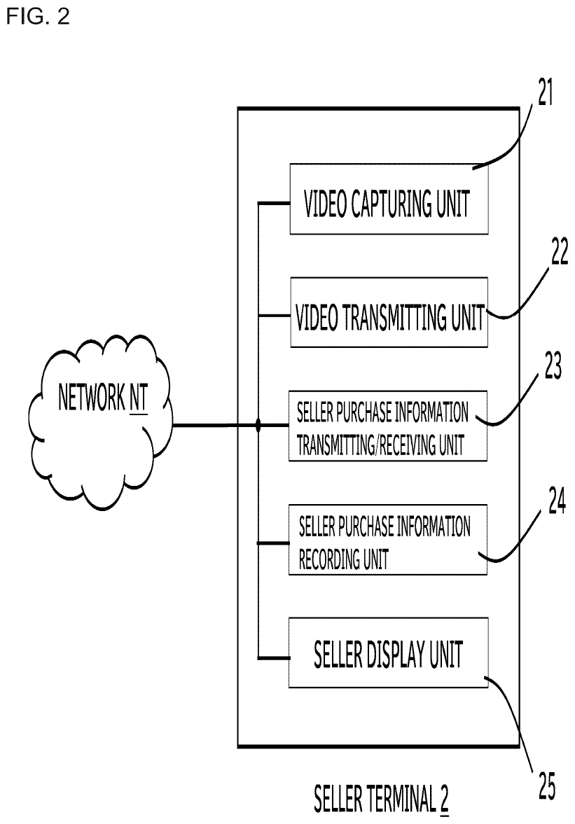

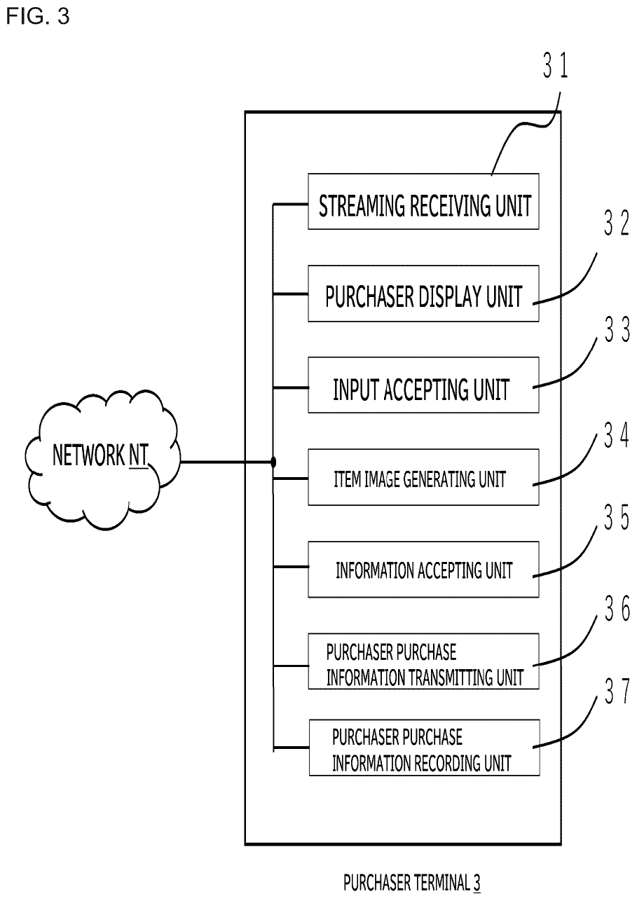

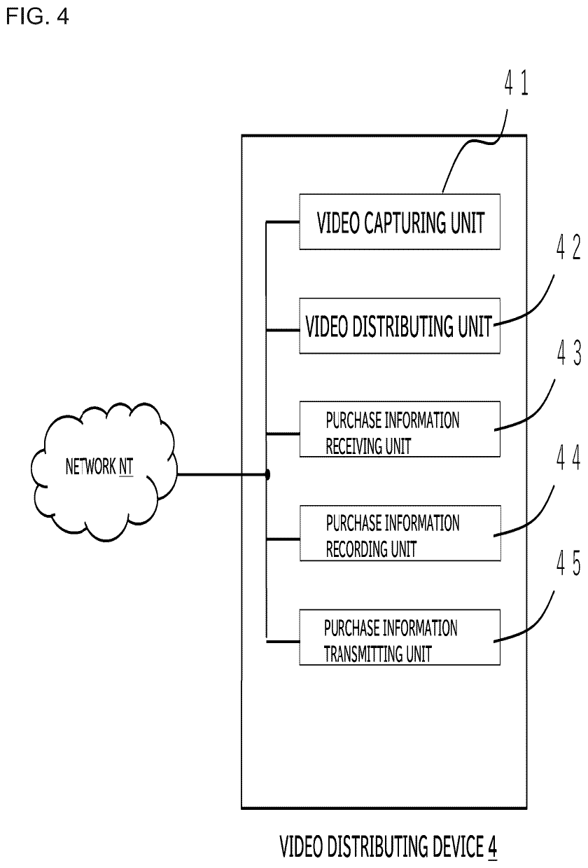

Video distribution systems according to example embodiments of the present invention will be described below with reference to the drawings. FIG. 1 shows an overall view of a video distribution system 1 according to an example embodiment of the present invention, FIG. 2 shows a configuration diagram of a seller terminal 2 included in the video distribution system 1 shown in FIG. 1, FIG. 3 shows a configuration diagram of a purchaser terminal 3 included in the video distribution system 1, and FIG. 4 shows a configuration diagram of a video distribution device 4 included in the video distribution system 1.

As shown in FIG. 1, the video distribution system 1 according to an example embodiment of the present invention includes the seller terminal 2 operated by a seller who sells products, the purchaser terminals 3 operated by purchasers who purchase the products sold by the seller, and the video distribution device 4 that handles various information related to commercial transactions between the seller and the purchasers. The seller terminal 2, the purchaser terminals 3, and the video distribution device 4 are connected to one another via a network NT, as shown in FIG. 1. Each of the seller terminal 2, the purchaser terminals 3, and the video distribution device 4 will be described in detail below.

The seller terminal 2 is a device operated by the seller to introduce the products in real time and conduct transactions with the purchasers. The seller terminal 2 is configured or programmed to include a plurality of functional units (a video capturing unit 21, a video transmitting unit 22, a purchase information transmitting/receiving unit 23, a seller purchase information recording unit 24, and a seller display unit 25), which will be described hereinafter. A personal computer, a tablet terminal, a smartphone, or the like, may be configured or programmed to perform the functions and provide the functional units of the seller terminal 2. Next, each of the functional units included in the seller terminal 2 will be described in detail below.

The video capturing unit 21 is configured or programmed to capture moving images of the products introduced by the seller. The video capturing unit 21 may be integrated with other units included in the seller terminal 2, for example, in the form of a smartphone. Alternatively, the video capturing unit 21 may be configured in a form in which a video camera, a digital camera, or the like is connected to the seller terminal 2. For example, by using a video camera, which is a device dedicated to video capturing, as the video capturing unit 21, the viewing angle and zoom capabilities can be enhanced compared to those of a smartphone, enabling the products to be introduced in detail from various angles.

The video transmitting unit 22 is configured or programmed to transmit the moving images (videos) captured by the video capturing unit 21 to the video distribution device 40 in real time. The video transmitting unit 22 is connected to the network NT by wired or wireless communication modules or methods.

Furthermore, by using various data compression techniques, the video transmitting unit 22 can transmit high-quality video data to the network while efficiently using line capacity. The seller terminal may include a plurality of video capturing units 21 so that the video transmitting unit 22 can edit videos captured by the plurality of video capturing units 21 into a single video for distribution, or can transmit a plurality of videos simultaneously via different channels to distribute product introductions from different perspectives at the same time.

The purchase information transmitting/receiving unit 23 is configured or programmed to transmit and receive purchase information to and from the video distribution device 4 via the network NT. The purchase information includes user information of the purchaser, information on the product that the purchaser wishes to purchase, a price at which the purchaser wishes to purchase, a transaction status, and the like. This allows the seller to immediately understand requests of the purchaser and take appropriate action.

The purchase information transmitting/receiving unit 23 may also be configured or programmed to simultaneously process information from a plurality of purchasers and manage transactions with the plurality of purchasers. The received purchase information can be saved in the seller purchase information recording unit 24 and can also be referred to.

The purchase information may also include questions, requests, and other information from the purchasers, and the purchase information transmitting/receiving unit 23 can receive such information to communicate with the seller.

The seller purchase information recording unit 24 is configured or programmed to save the received purchase information. The seller purchase information recording unit 24 includes a database to record a plurality of pieces of purchase information.

Additionally, the seller purchase information recording unit 24 may be configured or programmed to perform a retrieval function to extract specific purchase information. The seller purchase information recording unit 24 can extract purchase information corresponding to a video currently being distributed, or refer to purchase information when shipping a product after the video distribution has ended. The seller purchase information storage unit 24 may also be configured or programmed to perform a backup function to prevent loss of information. Additionally, to ensure security and privacy reasons, the purchase information is recorded in an encrypted form.

The seller display unit 25 is configured or programmed to display the video distributed by the video transmitting unit 22 and the purchase information from the seller purchase information recording unit 24 on a display of the seller terminal 2. The seller display unit 25 is configured or programmed to display the purchase information, stock status, messages from customers, and the like in an arrangement that is easy to view.

The seller display unit 25 may also be configured or programmed to perform a touch screen function superimposed on the display. This allows the seller to touch the display of the seller terminal 2 to display and check the purchase information on the display screen, and to input characters and numbers using a software keyboard.

Furthermore, the seller display unit 25 can be configured or programmed according to preferences of the seller, and to perform a function of highlighting important information and an alert function. This allows the seller to provide optimal customer service without overlooking important information.

The purchaser terminal 3 is a device operated by the purchaser in the video distribution system 1. The purchaser terminal 3 is configured or programmed to include a streaming receiving unit 31, a purchaser display unit 32, an input accepting unit 33, an item image generating unit 34, an information accepting unit 35, a purchaser purchase information transmitting unit 36, and a purchaser purchase information recording unit 37. A personal computer, a tablet terminal, a smartphone, or the like, may be configured or programmed to perform the functions or provide the functional units of the purchaser terminal 3. Each of the functional units of the purchaser terminal 3 will be described below.

The streaming receiving unit 31 is configured or programmed to receive a video in real time from the video distribution device 4 via the network NT.

The purchaser display unit 32 is configured or programmed to display the video and purchase information received from the streaming receiving unit 31 on a display of the purchaser terminal 3.

The input accepting unit 33 is configured or programmed to accept a purchase instruction given by the purchaser via a touch panel screen of the purchaser terminal 3. The input accepting unit 33 includes a touch panel superimposed on the display of the purchaser display unit 32. The purchaser selects a position in the video corresponding to an item that they wish to purchase by touching the displayed portion the item in the video. For a purchase instruction, a still image of a frame corresponding to the time when the purchaser touches the displayed portion the item in the video is displayed on the purchaser display unit. The purchase instruction may then be determined to be made when the input accepting unit detects that the area is continuously touched for a predetermined period. Alternatively, the purchaser may give a purchase instruction by sliding a finger in a circle around the displayed portion the item in the video, and the input accepting unit 33 may determine that the purchase instruction is made when it detects this gesture of the finger of the purchaser.

The item image generating unit 34 is configured or programmed to generate an image of the item in the video based on the purchase instruction accepted by the input accepting unit 33. The item image generating unit 34 is configured or programmed to extract a contour surrounding the item based on the position in the video selected by the purchaser on the screen, and generate the image of the item that the purchaser wishes to purchase. For the contour extraction, methods such as edge detection around a predetermined position, pattern matching, or object recognition algorithms based on machine learning may be used.

The information accepting unit 35 is configured or programmed to display a screen on the purchaser terminal 3 for the purchaser to input information such as a desired price, and accept the information input by the purchaser on the screen. For input, a software keyboard (not shown) is displayed on the screen, and character input is accepted as the purchaser operates the software keyboard via the touch panel. The information input by the purchaser includes user information of the purchaser, a desired purchase price of the product, a message to the seller, and the like.

The purchaser purchase information transmitting unit 36 is configured or programmed to associate the generated item image with the accepted information and transmit them to the video distribution device 4 as purchase information. The purchase information includes the user information of the purchaser, the desired purchase price of the product, the message to the seller, and the like accepted by the information accepting unit 35. Additionally, a telephone number, an IP address, an email address, and the like of the purchaser terminal 3 may be added to the purchaser information, using a function of the purchaser terminal 3. The purchase information transmitting unit 36 may be configured or programmed to use an encryption technique to ensure privacy and security in data transmission.

The video distribution device 4 is a device that links the seller terminal 2 and the purchaser terminals 3 described above. The video distribution device 4 is configured or programmed to include a plurality of functional units (a video receiving unit 41, a video distributing unit 42, a purchase information receiving unit 43, a purchase information recording unit 44, and a purchase information transmitting unit 45). As shown in FIG. 1, the video distribution device 4 is connected to the seller terminal 2 and the purchaser terminals 3 via the network NT, and a plurality of purchaser terminals 3 may be connected to a video stream from one seller terminal 2 to conduct commercial transactions. Each of the functional units will be described in detail below.

The video receiving unit 41 is configured or programmed to receive video data transmitted from the seller terminal. The video receiving unit 41 is configured or programmed to buffer the received video data, and transmit the buffered video data to the video distributing unit 42 regularly.

The video distributing unit 42 is configured or programmed to encode the video data received by the video receiving unit 41 into a video format capable of real-time streaming distribution, and then distribute it to one or more purchaser terminals 3. The encoding is performed by dividing the video data into chunks of a few seconds each using a streaming protocol such as HLS or MPEG-DASH, and compressing the chunks to a file size suitable for streaming according to the encoding standard H.264. The video distributing unit 42 is configured or programmed to perform a network management function, which enables to select a compression ratio, a resolution, and a frame rate according to the network communication environment and perform encoding for distribution. Additionally, depending on network conditions, the optimal communication environment can be selected for distribution.

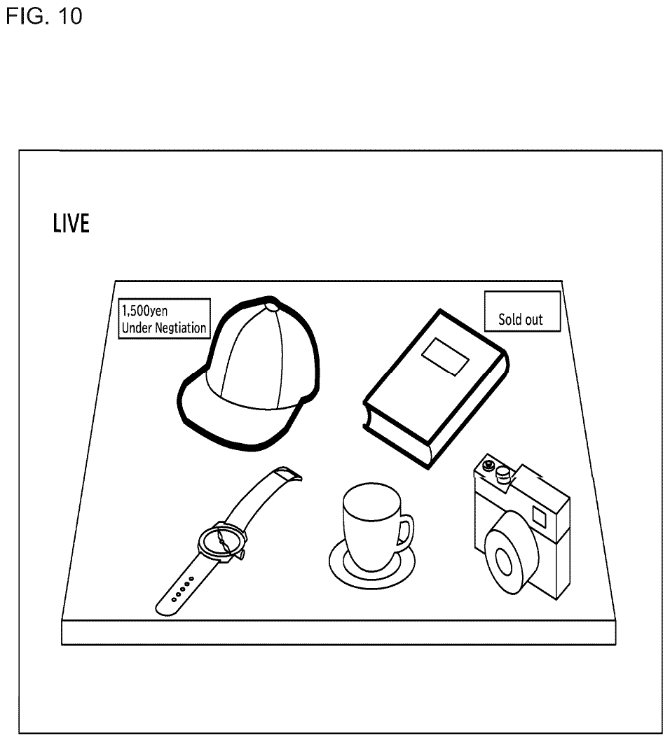

Furthermore, the video distributing unit 42 is configured or programmed to perform a function of comparing each frame of the video with an item image in the purchase information recorded in the purchase information recording unit 44 described hereinafter. This comparison function identifies the item in the video that the purchaser wishes to purchase, and generates and streams a video in which a display mode of the item in question has been changed. Specifically, for the item in the purchase information identified in the video, the contour of the item in question is highlighted in the video, and a video is generated in which information other than the item image in the purchase information is superimposed in an area adjacent to the item in question, as illustrated in FIG. 10. This function allows purchasers to check detailed information about the items in real time while viewing the video, which can encourage the purchaser to buy.

The purchase information receiving unit 43 is configured or programmed to receive the purchase information transmitted from the purchaser terminal 3. Information about the item that the purchaser wishes to purchase, such as its price and stock information, is received at this unit. The purchase information receiving unit 43 is configured or programmed to transfer the received information to the purchase information recording unit 44. For receiving the purchase information, communication may be performed using an encryption technique to ensure security and privacy.

The purchase information recording unit 44 is configured or programmed to record the purchase information received from the seller terminal 2 and the purchaser terminals 3. The purchase information recording unit 44 is configured or programmed to save the purchase information received from the purchase information receiving unit 43 in a database. The saved purchase information is used to generate a streaming video and to notify the seller of the purchase information. Additionally, the purchase information recording unit 44 is configured or programmed to perform periodic backups and data integrity checks in order to maintain data reliability.

The purchase information transmitting unit 45 is configured or programmed to transmit the recorded purchase information to the seller terminal 2 and the purchaser terminal 3.

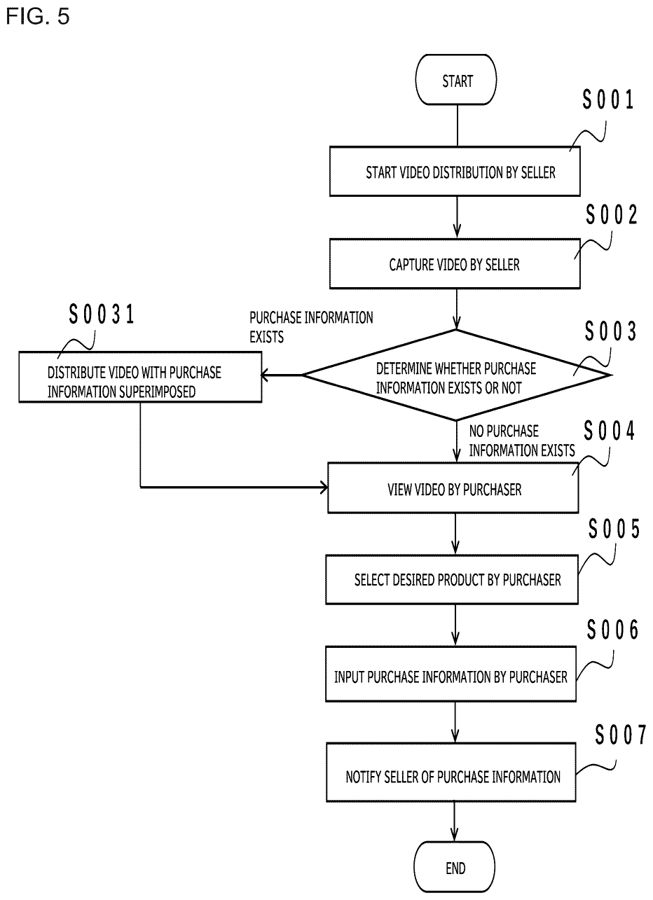

Next, a process flow relating to a commercial transaction using a video distribution system according to an example embodiment of the present invention will be described with reference to the drawings. First, with reference to FIG. 5, an example of operations from the start of a distribution until a purchaser identifies a product in the video they wish to purchase will be explained.

### <Step S001: Start Video Distribution by Seller>

The seller terminal 2 accesses the video distribution device 4 and starts a streaming distribution to the purchaser terminal 3. The seller announces to the purchaser terminal 3, which is the destination of a distribution, in advance that they will conduct a distribution and provides the purchaser terminal 3 with information such as the channel of the video distribution device 4 and the start date and time. The connection is then established by the purchaser terminal 3 accessing the video distribution device 4. Alternatively, the streaming distribution date and time, as well as information about the purchaser terminal 3 to be connected may be recorded in advance in the video distribution device 4. When the start time of the distribution arrives, the video distribution device 4 may access the purchaser terminal 3 and start the distribution.

### <Step S002: Capture Video by Seller>

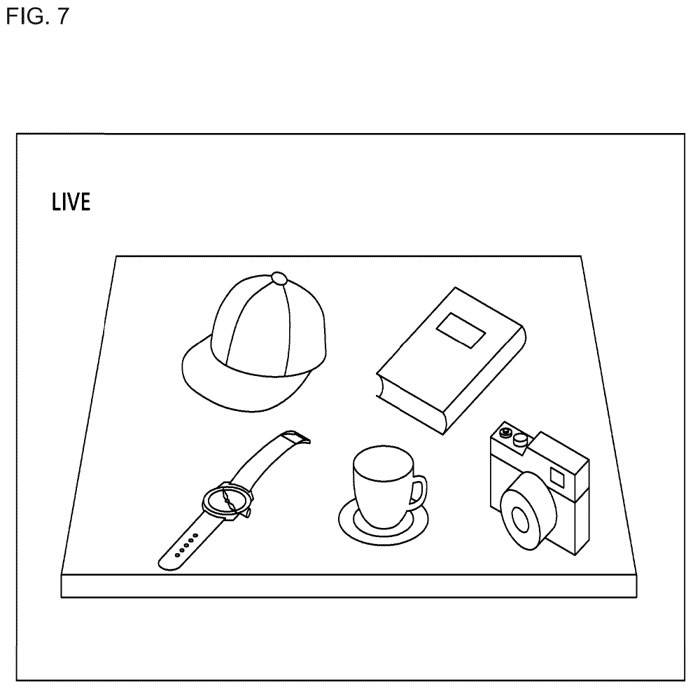

A video showing products is captured by using the video capturing unit 21 provided in the seller terminal 2. An example of the captured video is shown in FIG. 7. In the example shown in FIG. 7, five products displayed on a table by the seller, namely, a hat, a wristwatch, a book, a coffee cup set, and a digital camera are captured in a video. Without being limited to this, a video may be captured in which the seller appears and holds a product, or items not intended for sale by the seller may appear in a video. The captured video is transmitted to the video distribution device by the video transmitting unit 22. The video transmission is regularly performed during the video capture, while the streaming distribution continues throughout.

### <Step S003: Determine Whether Purchase Information Exists or Not>

The video receiving unit 41 of the video distribution device 4 receives the video transmitted from the seller terminal 2. Then, the video distributing unit 42 of the video distribution device 4 determines whether purchase information exists in the purchase information recording unit 44 for the received video. If no purchase information exists, the received video is encoded into a format suitable for streaming and streamed to the purchaser terminals 3, and the process proceeds to step S004. If the purchase information exists in the purchase information recording unit 44, the process proceeds to step S0031.

<Step S0031: Distribute Video with Purchase Information Superimposed>

The video distributing unit 42 retrieves the purchase information from the purchase information recording unit 44. The item image in the retrieved purchase information is compared with each frame of the video, and if an item corresponding to the item image in the purchase information exists in a frame of the video, a video is generated in which a display mode of the item in question has been changed. Specifically, as illustrated in FIG. 10, a video is generated in which the contour of the item, which corresponds to the purchase information, identified in the video is highlighted, and information other than the item image in the purchase information is superimposed in an area adjacent to the item in question. Specifically, the displayed information includes desired purchase price provided by the purchaser for the item and a transaction status for the item (transaction confirmed, under negotiation, and the like). The video distributing unit generates a video in such a way that the information to be displayed is superimposed in an area surrounding the display portion the item in question, without overlapping it. In the example of FIG. 10, a hat and a book are displayed with their contours highlighted. For the “hat,” the purchase price of 1500 yen is under negotiation, and the currently negotiated price is displayed in the area to the left of the “hat.” For the “book,” on the other hand, its transaction status is “Transaction Concluded,” and an indication of “Sold Out” is displayed in the adjacent upper-right area next to the “book.” The video distributing unit encodes the generated video into a format suitable for streaming and streams it to the purchaser terminal.

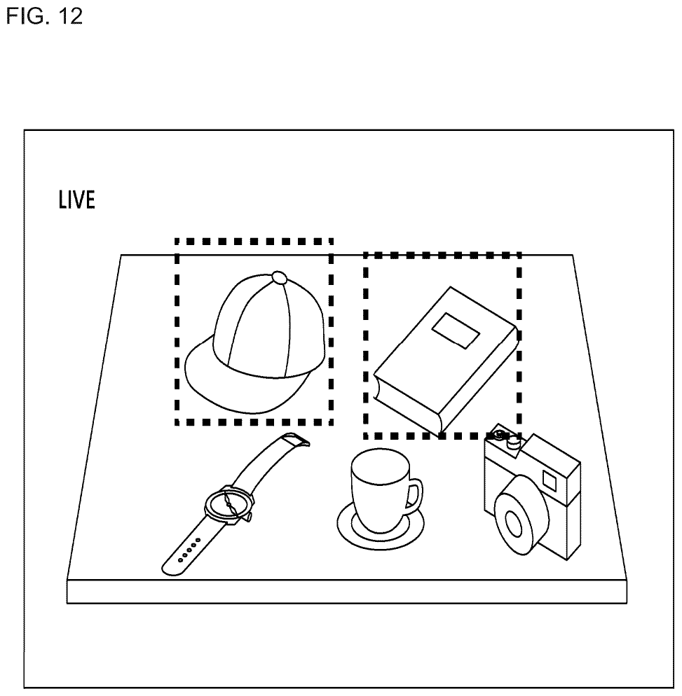

The ways of highlighting the contour of the item in question in the video and displaying information other than the item image in the purchase information are not limited to the example of FIG. 10. For example, it is conceivable to highlight the item by surrounding it with a cursor as shown in FIG. 12, or to gray out a product that has been sold out after a negotiation has been concluded.

### <Step S004: View Video by Purchaser>

The purchaser terminal 3 receives the video streamed from the video distribution device 4 by the streaming receiving unit 31, and displays the video on the purchaser display unit 32. An example of the video viewed by the purchaser is shown in FIG. 7. The example shown in FIG. 7 is an example in a case where no purchase information exists in the purchase information recording unit 44 of the video distribution device 4. If purchase information exists in the purchase information recording unit 44 of the video distribution device 4, a video is displayed in which the display mode of the item for which purchase information exists is changed as in FIG. 10.

The purchaser views the displayed video and checks whether any item of interest is present in the video. If the purchaser is interested in an item in the video and wishes to purchase it, the process proceeds to step S005. If the purchaser is not interested in any item in the video, the video distribution process in steps S001 and S002 continues, and the video viewing by the purchaser ends upon completion of the streaming distribution from the seller terminal.

### <Step S005: Select Product Purchaser Wishes to Purchase>

When the purchaser finds a product in the video that they wish to purchase, the purchaser uses a touch panel of the purchaser terminal 3 to touch the area of the product that they wish to purchase. The input accepting unit 33 of the purchaser terminal 3 detects the touch by the purchaser and accepts a purchase instruction of the product in question. When the input accepting unit 33 accepts the purchase instruction, the item image generating unit 34 extracts the contour of the product for which the purchase instruction has been given and generates an item image.

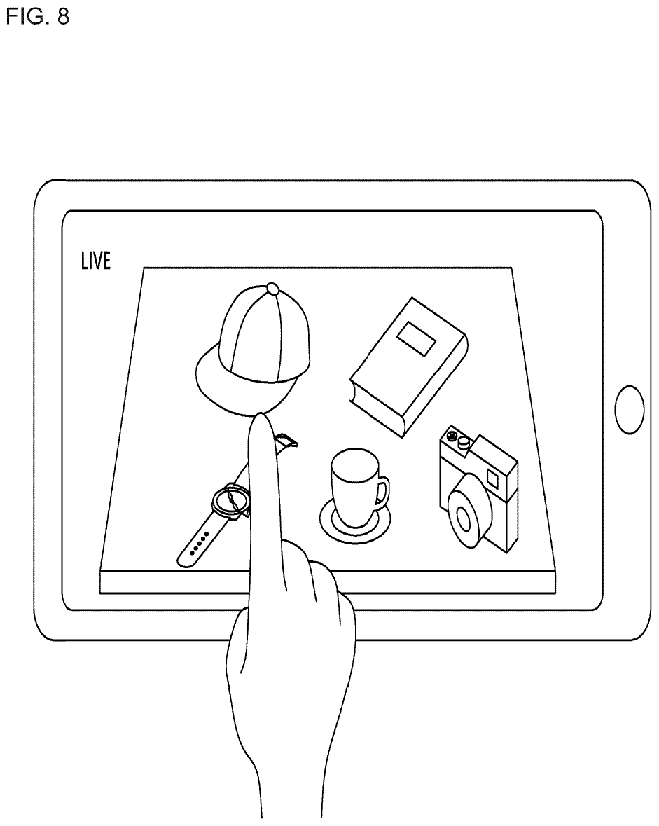

FIG. 8 shows an example in a case where the purchaser selects a product that they wish to purchase. If the purchaser wishes to purchase, for example, a “hat” among five products (a hat, a wristwatch, a book, a coffee cup set, and a digital camera) displayed on a table in the video, the purchaser gives a purchase instruction by touching with a finger the area on the screen of their purchaser terminal 3, such as a smartphone, where the “hat” is displayed. As described above, a purchase instruction may also be given by continuously touching the area where the “hat” is displayed for a predetermined period of time, or by a gesture such as sliding a finger around the “hat.”

### <Step S006: Input Purchase Information by Purchaser>

The information accepting unit 35 of the purchaser terminal 3 displays an information input screen 51 for the purchaser to purchase the product, on the purchaser display unit 32. The purchaser uses this screen to input a user name, a desired purchase price, and the like. The purchaser purchase information transmitting unit 36 combines the input information with the item image generated by the item image generating unit 34 to create purchase information, and transmits it to the video distribution device 4, with the transaction status in the purchase information set to “Under Negotiation.”

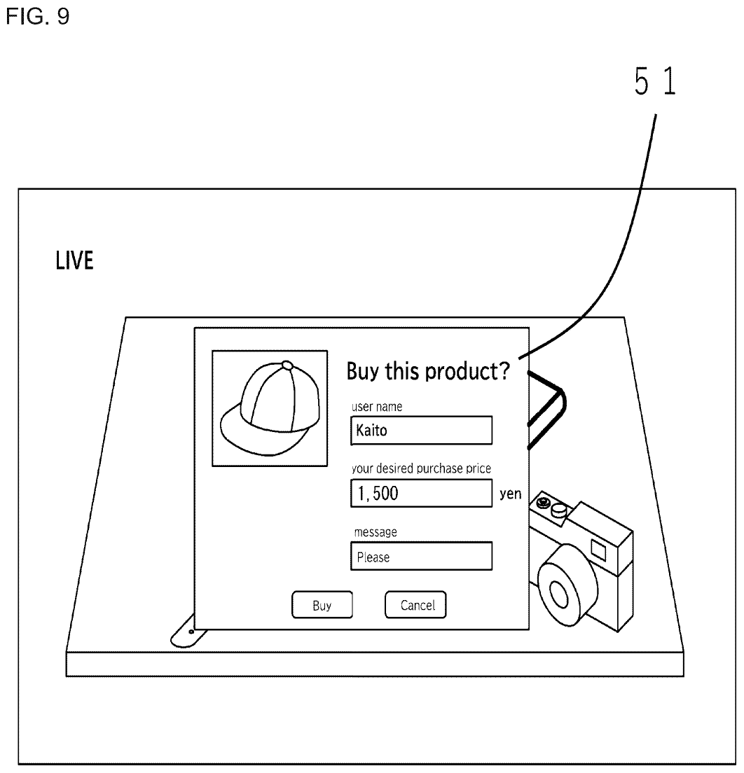

An example of the information input screen 51 is shown in FIG. 9. When the purchaser selects the “hat” in the video shown in FIG. 8 on the screen of the purchaser terminal, the information input screen 51 displays the item image of the “hat” as well as input fields for a user name, a desired purchase price, and a message. The purchaser inputs a user name, a desired purchase price, and a message into the input fields of the information input screen 51 via the input accepting unit 33. Although “user name: Kaito,” “desired purchase price: 1500 yen,” and “message: Please” are shown as examples of input on the information input screen 51, other input fields may also be included on the information input screen 51. In other words, the purchase information may include items other than the user name, the desired purchase price, and the message.

Additionally, two options, “Buy” and “Cancel,” are displayed at the bottom of the screen, and the purchaser can make a decision by touching either one of the options. When the purchaser touches the “Buy” option, the information accepting unit 35 accepts the input information as purchase information. When the purchaser touches the “Cancel,” the information input screen 51 disappears and the purchase instruction is cancelled. After cancellation of the purchase instruction, streaming viewing is maintained.

### <Step S007: Notify Seller of Purchase Information>

The purchase information receiving unit 43 of the video distribution device 4 receives the purchase information transmitted from the purchaser terminal 3. The received purchase information is recorded in the purchase information recording unit 44, with the transaction status set to “Under Negotiation.” Then, the purchase information transmitting unit 45 transmits the recorded purchase information to the seller terminal 2. The seller purchase information transmitting/receiving unit 23 of the seller terminal 2 receives the purchase information transmitted from the video distribution device 4 and records it in the seller purchase information recording unit 24.

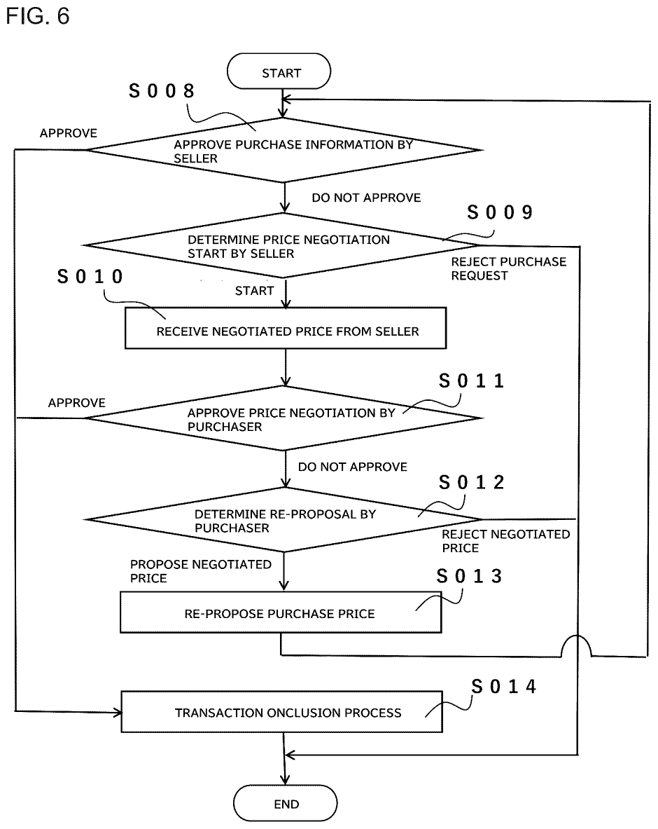

Through the above process from step S001 to step S007, the desired product of the purchaser and the related purchase information are notified to the seller. Next, a transaction with the purchaser after the seller receives the purchase information will be described with reference to FIG. 6.

### <Step S008: Approve Purchase Information by Seller>

The seller display unit 25 retrieves the purchase information in the seller purchase information recording unit 24, and displays a purchase information confirmation screen 52 for accepting an approval for the purchase information. The purchase information confirmation screen 52 allows the seller to confirm and approve information such as the user name and the desired purchase price of the purchaser.

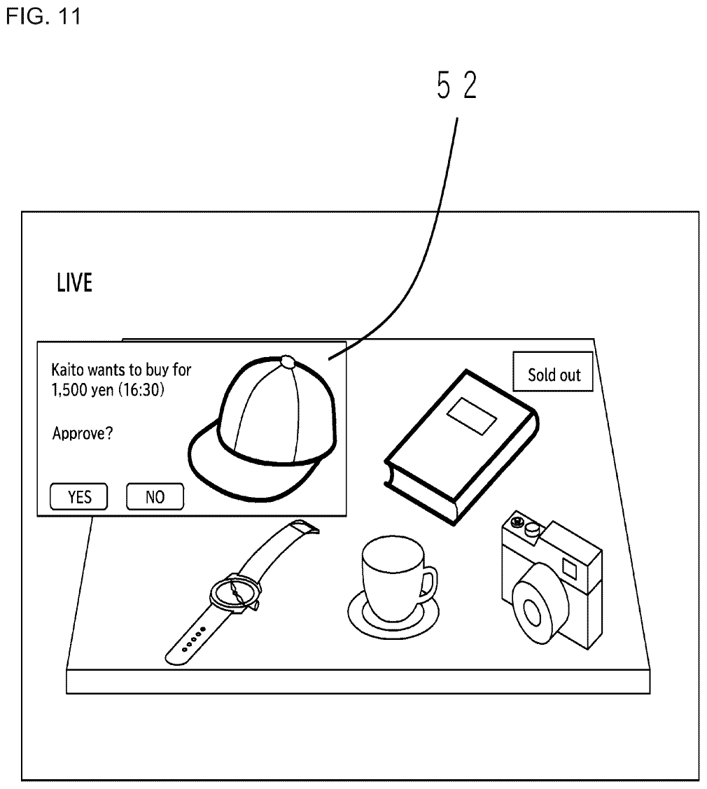

An example of the purchase information confirmation screen 52 is shown in FIG. 11. As shown in FIG. 11, the purchase information confirmation screen 52 is displayed on the seller display unit 25 of the seller terminal 2. If the seller approves the desired purchase price by the purchaser, the transaction is confirmed by touching a “Yes” option button displayed at the bottom of the screen. If the transaction is confirmed, the process proceeds to step S014.

If the seller does not approve the desired purchase price input by the purchaser, the seller touches a “No” option button, and the process then proceeds to step S009.

### <Step S009: Determine Price Negotiation Start by Seller>

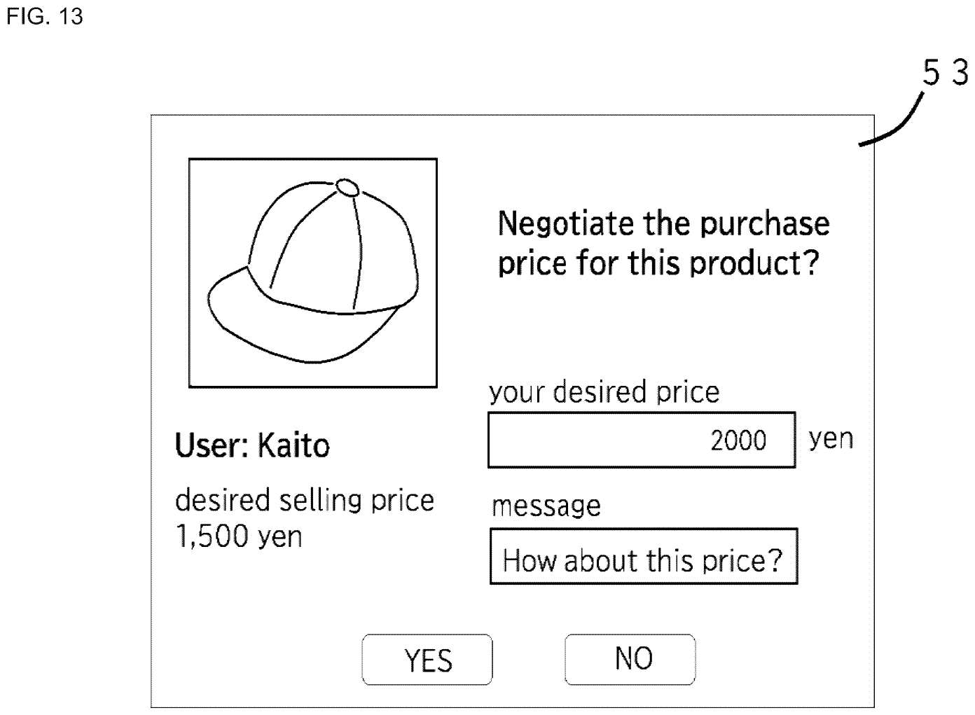

If the seller selects “No” on the purchase information confirmation screen 52, the seller display unit 25 displays a negotiation screen 53 shown in FIG. 13 to accept a determination whether the seller rejects the purchase information from the purchaser or negotiates with the purchaser.

The seller inputs a proposed price and other information on the negotiation screen 53. Upon accepting the input via the “Yes” button, the seller purchase information transmitting/receiving unit 23 transmits the purchase information for the product in question to the video distribution device 4, with the transaction status set to “Under Negotiation” and with the desired purchase price set to a re-proposed price. The process then proceeds to step S010.

If “No” is selected, the seller purchase information transmitting/receiving unit 23 records the purchase information of the product in question as “Negotiation Failed” in the seller purchase information storage unit 24 and transmits it to the video distribution device 4. As a result, the transaction is terminated. After the transaction is terminated, the video distribution process in steps S001 and S002 continues, and the video viewing by the purchaser ends upon completion of the streaming distribution from the seller terminal 2.

<Step S010: Receive Negotiated Price from Seller>

The purchase information transmitting unit 45 of the video distribution device 4 receives the purchase information, and records the transaction status of the purchase information as “Under Negotiation” in the purchase information recording unit 44. After recording into the purchase information recording unit 44, the purchase information transmitting unit 45 transmits the purchase information to the purchaser terminal 3. The purchaser purchase information transmitting/receiving unit 36 of the purchaser terminal 3 receives the purchase information.

### <Step S011: Approve Negotiated Price by Purchaser>

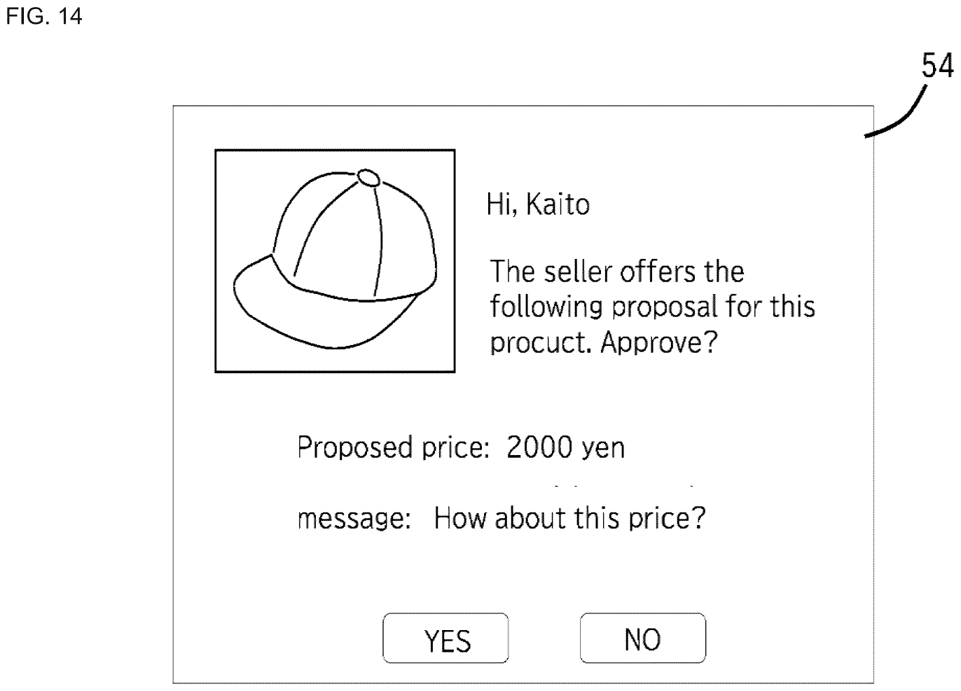

The purchaser display unit 32 of the purchaser terminal 3 displays a proposal approval screen 54 shown in FIG. 14. The proposal approval screen 54 accepts a determination by the purchaser on whether or not to approve the proposal from the seller. If the purchaser approves the proposal of the seller on the proposal approval screen 54, the negotiation for the product in question is concluded, and the process proceeds to step S014. If the purchaser does not approve the proposal, the process proceeds to step S012.

### <Step S012: Determine New Proposal by Purchaser>

The purchaser display unit 32 changes the display of the proposal approval screen 54 and accepts a selection from the seller as to whether to propose a new price again or reject the purchase request (not shown). If “Propose price again” is selected on the price negotiation screen 53, the process proceeds to step S013.

If “Reject” is selected on the price negotiation screen 53, the purchaser purchase information transmitting/receiving unit of the purchaser terminal 3 sets the transaction status of the purchase information for the product in question to “Negotiation Failed” and transmits the purchase information to the video distribution device 4. The video distribution device 4 receives the purchase information by the purchase information receiving unit 43 and deletes the purchase information for the product in question from the purchase information recording unit 44. The price negotiation transaction is then terminated. After the transaction is terminated, the video distribution process in steps S001 and S002 continues, and the video viewing by the purchaser ends upon completion of the streaming distribution from the seller terminal 2.

### <Step S013: Propose Purchase Price Again>

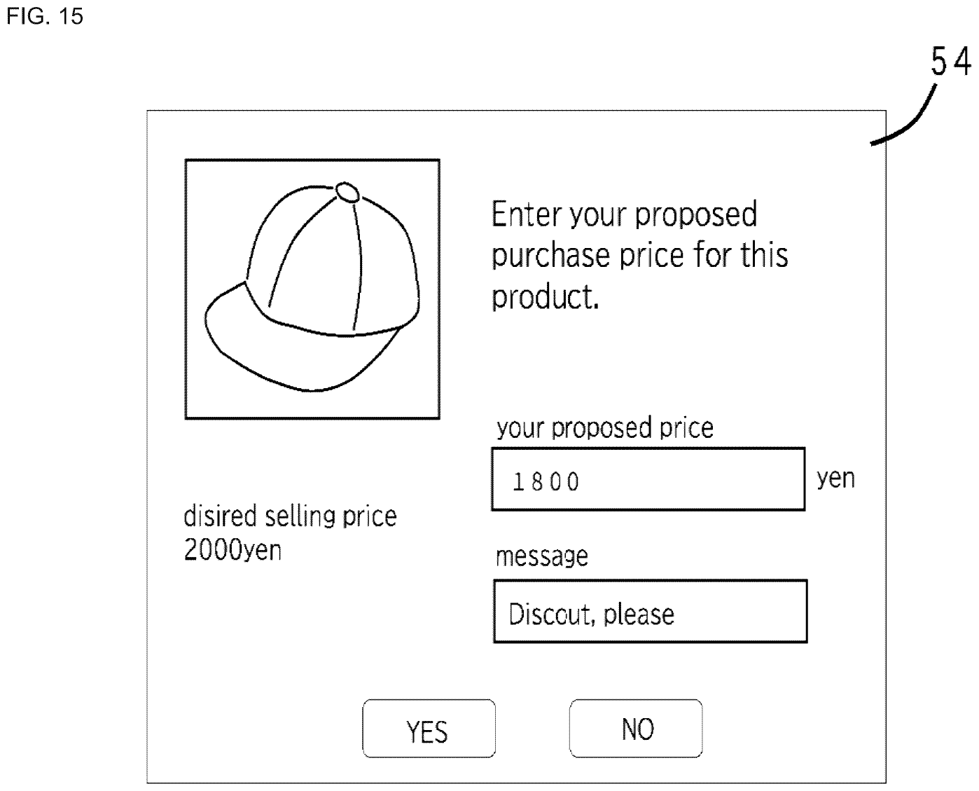

If a new price is proposed, the price negotiation screen 53 displays input fields for a proposed purchase price and a message, as shown in FIG. 15, and accepts input from the purchaser. The purchaser purchase information transmitting unit 36 of the purchaser terminal 3 updates the purchase information for the product in question with the information accepted on the price negotiation screen 53, and sets the transaction status of the purchase information in question to “Under Negotiation” and transmits the purchase information to the video distribution device.

The video distribution device 4 accepts the purchase information by the purchase information receiving unit 43 and updates the information in the purchase information recording unit 44. The process then returns to step S008, and repeats step S008 to step S013 until the price negotiation is concluded.

### <Step S014: Transaction Confirmation Process>

When the purchase information is approved by the seller, the seller purchase information recording unit 24 of the seller terminal 2 updates the purchase information and records that the transaction has been confirmed. At the same time, the purchaser purchase information transmitting unit 36 transmits the updated purchase information to the video distribution device 4. The video distribution device 4 receives the purchase information by the purchase information receiving unit 43, and records the purchase information in the purchase information recording unit 44, with the transaction status of the purchase information set to “Transaction Confirmed.”

The transaction process is carried out according to the above process flow. After the transaction is confirmed, the video distribution process in steps S001 and S002 continues, and the video viewing by the purchaser ends upon completion of the streaming distribution from the seller terminal.

After the streaming ends, the seller performs a payment process for the product in a predetermined method based on the purchase information input by the purchaser. Once payment is completed, the seller carries out a shipment procedure for the product. The purchase information displayed on the seller terminal 2 includes information about the purchaser and the product price, and the seller refers to this information to process the order.

For the product payment, an external service may be linked with the video distribution system so that the payment of the product price by the purchaser and the shipment of the product are automatically arranged once the transaction is confirmed.

As described above, according to this example embodiment, the seller can immediately start a commercial transaction without the need to prepare a database or a link for a product in advance. Additionally, the purchaser can intuitively select an item that they view in the video, which encourages the purchaser to buy. In the first example embodiment described above, a one-to-one commercial transaction between a purchaser and a seller has been described. In a second example embodiment described below, however, a seller can simultaneously conduct commercial transactions for a plurality of products in a streaming video with a plurality of purchasers who wish to purchase them. The seller may conduct commercial transactions for a plurality of products with a plurality of different purchasers, and may conduct commercial transactions for the same product with a plurality of purchasers. In this case, the seller accepts purchase information from a plurality of purchasers, but the transaction is confirmed with a purchaser approved by the seller on the purchase information confirmation screen 52. In the example screen shown in FIG. 10, the seller conducts a transaction for a “hat” while a purchase transaction for a “book” with a different purchaser is in progress. The transaction for the “book” is shown as having been concluded.

Differences in configuration between this second example embodiment and the first example embodiment will be described below.

The purchase information transmitting unit 45 of the video distribution device 4 is further configured or programmed to perform a function of transmitting the updated purchase information to all purchaser terminals 3 when the purchase information in the purchase information recording unit is updated.

The purchaser terminal 3 is configured or programmed to further include a purchaser purchase information recording unit 37. The purchaser purchase information transmitting unit 36 is further configured or programmed to perform a function of receiving the purchase information transmitted from the video distribution device 4 and recording it into the purchaser purchase information recording unit 37.

The purchaser purchase information transmitting/receiving unit 23 of the seller terminal 2 is further configured or programmed to perform a function of transmitting the purchase information to the video distribution device 4.

The process flow in this example embodiment is similar to that in the first example embodiment shown in FIGS. 5 and 6. Steps involving processes different from those in the first example embodiment will be described below.

### <Step S005: Select Desired Product by Purchaser>

The input accepting unit 33 of the purchaser terminal 3 accepts an instruction by the purchaser touching an item having a changed display mode in the video. Since the purchase information exists for the item having the changed display mode in the video, the information accepting unit 35 retrieves the purchase information corresponding to the instructed item from the purchaser purchase information recording unit 37.

It should be noted that the input accepting unit 33 does not accept a touch on an item for which a transaction has already been concluded, even if the purchaser gives an instruction by touching the item, since no further transaction is conducted for the item. For example, for the book in FIG. 11, the characters “Sold Out” are displayed as purchase information indicating that the transaction has been concluded, and the book is displayed with its display mode changed accordingly. Even if the purchaser touches the area where the book is displayed, the input accepting unit 33 does not perform any operation. It should be noted that for an item for which a transaction has been concluded, the item may be displayed in a way that makes it easier to see that it cannot be touched, such as by graying out the item itself.

### <S005: Input Purchase Information by Purchaser>

The information accepting unit 35 displays on the purchaser terminal 3 a screen for inputting new purchase information from the purchaser, along with the purchase information for the instructed item retrieved from the purchaser purchase information recording unit 37, and accepts input from the purchaser. For example, the currently negotiated price is newly displayed on the information input screen 51 in FIG. 9, and input fields are provided to accept input of items such as user information, a desired purchase price, and a message. The input information is combined with an item image in the purchase information corresponding to the instructed item to create new purchase information, and transmitted to the video distribution device 4 via the purchaser purchase information transmitting unit 36.

### <S008: Approve Purchase Information by Seller Terminal>

When the seller purchase information transmitting/receiving unit 23 receives the purchase information, the seller display unit 25 retrieves the purchase information in the seller purchase information recording unit 24 and displays the purchase information confirmation screen 52 for accepting approval of the purchase information. In the first example embodiment, the transaction is confirmed by touching the “Yes” option on the purchase information confirmation screen 52. However, in this example embodiment, when “Yes” is touched, three options, i.e., “Approve,” “Pending,” and “Negotiate,” are displayed, allowing the seller to make a selection. If “Approve” is touched, the transaction is confirmed, and the process proceeds to step S014. If “Negotiate” is touched, the process proceeds to step S009, and price negotiation continues as in the first example embodiment.

If “Pending” is touched, the transaction status of the purchase information is updated to “Pending” and recorded into the purchaser purchase information recording unit 37, and the purchaser purchase information transmitting unit 36 transmits the updated purchase information to the video distribution device 4. The process then returns to step S002, and the streaming distribution continues. In step S004, for the purchase information having its transaction status set to “Pending,” an image is generated and distributed to the purchaser terminal 3 in which the information “1500 yen under negotiation” is displayed in the area around the “hat,” as shown in FIG. 10. This allows a purchaser to view the negotiation status of other purchasers. If the purchaser wishes to purchase the product, they can transmit the purchase request by inputting new purchase information as in steps S004 and S005. The same steps are then repeated until the purchase information is approved by the seller and the transaction is completed.

As described above, according to this example embodiment, a plurality of purchasers can participate in the commercial transaction of this example embodiment, and a purchaser can check products and prices that other purchasers wish to purchase in real time through a distributed video. The purchasers can experience participating in a real-time auction, making commercial transactions more enjoyable. The seller can expect to be able to sell products at higher prices.

The present invention is not limited to the above example embodiments, and various modifications can be made in practice without departing from the scope and spirit of the invention. Furthermore, the example embodiments may be implemented in combination as appropriate, in which case the combined effects can be obtained.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A video distribution system for distributing a video related to a commercial transaction via a network, the video distribution system comprising:
a seller terminal;
a purchaser terminal; and
a video distribution device; wherein
the seller terminal is configured or programmed to include:
a video capturing unit configured or programmed to capture the video; and
a video transmitting unit configured or programmed to transmit the video to the video distribution device;
the video distribution device is configured or programmed to include:
a video receiving unit configured or programmed to receive the video captured by the seller terminal, from the seller terminal;
a video distributing unit configured or programmed to stream the video received by the video receiving unit to the purchaser terminal;
a purchase information receiving unit configured or programmed to receive purchase information from the purchaser terminal; and
a purchase information recording unit configured or programmed to record the purchase information;
the purchaser terminal is configured or programmed to include:
a streaming receiving unit configured or programmed to receive the video streamed from the video distributing unit;
a purchaser display unit configured or programmed to display the video received by the streaming receiving unit;
an input accepting unit including a touch panel superimposed on the purchaser display unit and configured or programmed to accept a purchase instruction for an item in the video that a purchaser wishes to purchase, by the purchaser touching a corresponding area of the touch panel;
an item image generating unit configured or programmed to extract a contour of the item present in a frame and an area of the video corresponding to the purchase instruction accepted by the input accepting unit, and extract an image of the item from the frame along the contour;
an information accepting unit configured or programmed to cause the purchaser display unit to display a screen allowing the purchaser to input information, including a desired purchase price of the item by the purchaser, and accept the information; and
a purchaser purchase information transmitting/receiving unit configured or programmed to transmit the item image generated by the item image generating unit, the information accepted by the information accepting unit, and a transaction status of the item as the purchase information to the video distribution device; and
the video distribution unit is configured or programmed to:
compare the item image in the purchase information recording unit with each frame of the video;
extract an item in the video corresponding to the item image;
change a display mode of the extracted item in the video; and
generate a video in which at least either one of the desired purchase price and the transaction status is superimposed and displayed in an area adjacent to the item.

2. The video distribution system according to claim 1, wherein
the video distribution device is configured or programmed to further include:
a purchase information transmitting unit configured or programmed to transmit the purchase information to the purchaser terminal;
the seller terminal is configured or programmed to further include:
a seller purchase information transmitting/receiving unit configured or programmed to transmit/receive the purchase information to/from the video distribution device;
a seller purchase information recording unit configured or programmed to store the purchase information; and
a seller display unit configured or programmed to display a purchase information confirmation screen allowing input of a determination on whether to approve a sale of the item at the desired purchase price, with respect to the purchase information received by the seller purchase information transmitting/receiving unit, and accept input from the seller;
the seller purchase information transmitting/receiving unit is configured or programmed to update a transaction status of the purchase information depending on a result of the approval and transmit the purchase information to the video distribution device; and
the video distributing unit is configured or programmed to generate a video in which a display mode of the item in the video has been changed according to a transaction status in the purchase information.

3. The video distribution system according to claim 1, wherein the input accepting unit is configured or programmed to:
cause the purchaser display unit to display the video in a paused state at a frame of the video corresponding to a time when the purchase instruction is accepted; and
determine that the purchase instruction is completed when the touch in the area continues for a predetermined period of time.

4. The video distribution system according to claim 2, wherein the input accepting unit is configured or programmed to:
cause the purchaser display unit to display the video in a paused state at a frame of the video corresponding to a time when the purchase instruction is accepted; and
determine that the purchase instruction is completed when the touch in the area continues for a predetermined period of time.

5. The video distribution system according to claim 1, wherein the display mode of the item in the video distributing unit is a mode highlighting a contour of the extracted item.

6. The video distribution system according to claim 2, wherein the display mode of the item in the video distributing unit is a mode highlighting a contour of the extracted item.

7. A video distribution device for distributing a video related to a commercial transaction, the video distribution device comprising:
a video receiving unit configured or programmed to receive the video captured by a seller terminal, from the seller terminal;
a video distributing unit configured or programmed to stream the video received by the video receiving unit to a purchaser terminal;
a purchase information receiving unit configured or programmed to receive, from the purchaser terminal, purchase information including an image of an item in the video that the purchaser instructs to purchase via the purchaser terminal, and a price of the item; and
a purchase information recording unit configured or programmed to record the purchase information; wherein
the video distribution unit is configured or programmed to:
compare the item image in the purchase information recording unit with each frame of the video;
extract an item in the video corresponding to the item image;
change a display mode of the extracted item; and
generate a video in which the price of the item in the purchase information is superimposed and displayed in an area adjacent to the item.
